(19) United States
(12) Patent Application Publication
(10) Pub. No.: US 2026/0261167 A1
(43) Pub. Date: Sep. 3, 2026

(54) WINDING TRANSPOSITIONS AND CROSS CONNECTIONS FOR GENERATORS AND MOTORS

(71) Applicant: Timken Gears & Services Inc., King of Prussia, PA (US)

(72) Inventors: Jan H. de Swardt, Eustis, FL (US); Randall W. Russell, Kennewick, WA (US); James G. Wilson, Prosser, WA (US); Jeffrey S. Rickel, Kennewick, WA (US)

(21) Appl. No.: 19/285,141

(22) Filed: Jul. 30, 2025

Related U.S. Application Data
(60) Provisional application No. 63/764,899, filed on Feb. 28, 2025.

(51) Int. Cl. H02K 1/16; H02K 3/28; H02K 3/487; H02K 15/026; H02K 15/50

(52) U.S. Cl. CPC H02K 1/16; H02K 3/28; H02K 3/487; H02K 15/026; H02K 15/50

(57) ABSTRACT

Stators for use in electric machines and methods for refurbishing the same. One example includes increasing a number of turns per coil forming stator windings of the stator and reducing a number of transpositions and cross connections of the stator windings. Wedges forming the core may be split into sections that are separated by gaps to assist with the flow of resin.

### RELATED APPLICATIONS

This application claims the benefit of U.S. Provisional Patent Application No. 63/764,899, filed Feb. 28, 2025, the entire content of which is hereby incorporated by reference.

### SUMMARY

Generators, such as dual-speed machines and wind generators, experience stator failures that result in needing replacement of the stator winding.

Generators, such as Doubly Fed Induction Generators (DFIG) wind generators experience stator failures that result in needing replacement of the stator winding. The original designs of these generators include a high number of transpositions, which increase complexity and lead time during repairs. Additionally, these designs thus incorporate transpositions in both the series connections, as well as the cross connections, which introduce extra brazing joints that become points of potential failure. These factors create challenges for repair technicians, resulting in higher maintenance costs and reduced reliability due to localized heating and inefficient current distribution.

Traditional winding designs with five or fewer turns per coil experience increased circulating and eddy current losses due to unequal conductor lengths. These additional losses result in reduced power output, increased temperature, and decreased operational life. Traditional transposition and cross-connection methods are complex, time-consuming, and prone to reliability issues.

Examples described herein introduce a stator winding design that addresses the noted issues. Examples described herein may apply to both generators, including wind generators, and electric machines such as motors. Examples described herein provide for reduced transpositions, reduced cross connections, and improvement of turns per coil that enhances reliability and efficiency in both repaired generators and new generators.

In some aspects, the number of parallel circuits is doubled. For example, parallel circuits may be increased from two to four, subsequently doubling the number of turns per coil from two to four. In some aspects, the current number of parallel circuits may be multiplied by a factor of two, three, four, six, or eight, correspondingly increasing the number of turns per coil by the same factor. The increase of the number of parallel circuits may reduce cross connections and transpositions to minimize circulating and eddy currents, reduce the labor for these connections, and improve performance of the electric machines.

In some aspects, the number of parallel circuit is a whole factor of the number of poles, such as double the poles. For example, a four-pole machine may include one, two, or four parallel circuits. A six-pole machine may include one, two, three, or six parallel circuits. A twelve-pole machine may include one, two, three, four, six, or twelve parallel circuits. When increasing the number of parallel circuits, the turns per coil may be increased by the same factor. For example, a twelve-pole winding with three turns per coil and three parallel circuits may increase to four parallel circuits and four turns per coil. Similarly, if a twelve-pole, three turn per coil two-circuit design is changed to a six-circuit design, the turns per coil increases to nine turns per coil. Such aspects provide consistent magnetic flux distribution and reduces lead time for repairs.

In some aspects, a thixotropic resin is provided to a core of stators. To assist with the flow of the resin over the core and into the winding, wedges forming the core may be split into sections that are separated by gaps.

Other aspects of the disclosure will become apparent by consideration of the detailed description and accompanying drawings.

### BRIEF DESCRIPTION OF THE DRAWINGS

FIG. 1 illustrates a cross sectional view of stator and rotor cores and windings according to some aspects of the disclosure.

FIG. 2 illustrates a series cross connection transposition according to some aspects of the disclosure.

FIG. 3 illustrates transposition of parallel conductors in series connection according to some aspects of the disclosure.

FIG. 4 illustrates a connection diagram for a high speed winding according to some aspects of the disclosure.

FIG. 5 illustrates a component of the high speed winding of FIG. 4 according to some aspects of the disclosure.

FIG. 6 illustrates another component of the high speed winding of FIG. 4 according to some aspects of the disclosure.

FIG. 7 illustrates the transposition of parallel conductors in series connection according to some aspects of the disclosure.

FIG. 8 illustrates a connection diagram of improved high speed winding according to some aspects of the disclosure.

FIG. 9 illustrates a component of the improved high speed winding of FIG. 8 according to some aspects of the disclosure.

FIG. 10 illustrates an example core having radial vents, according to some aspects of the disclosure.

FIG. 11 illustrates an example core without radial vents, according to some aspects of the disclosure.

FIG. 12 illustrates an example core having entry areas for a resin, according to some aspects of the disclosure.

FIG. 13 illustrates another example core having entry areas for a resin, according to some aspects of the disclosure.

FIG. 14 illustrates a perspective view of an example wedge of the core of FIG. 13, according to some aspects of the disclosure.

Other aspects of the disclosure described herein will become apparent by consideration of the detailed description.

### DETAILED DESCRIPTION

Before any examples and aspects of the disclosure are explained in detail, it is to be understood that the disclosure is not limited in its application to the details of construction and the arrangement of components set forth in the following description or illustrated in the following drawings. The disclosure is capable of other implementations and of being practiced or of being carried out in various ways.

Examples described herein may be applied to either or both of the high-speed and low-speed windings. As one example, for an ABB 1300 kW wind generator, examples described herein may be provided for the high-speed windings. The ABB 1300 kW wind generator may provide 1300/250 KW of power, a voltage of 690 V, a frequency of 60 Hz, and a speed of 1812/1208 RPM. However, other configurations may be implemented for either or both windings in different generator models.

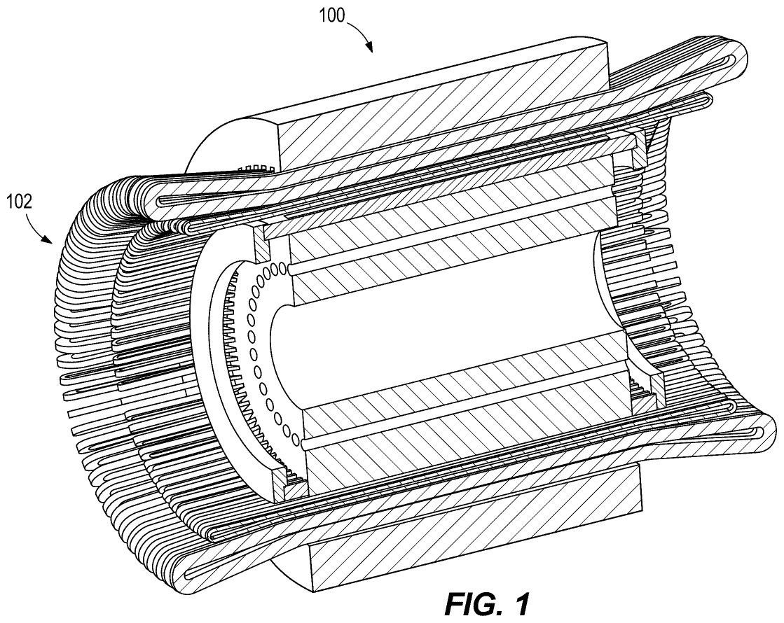

FIG. 1 illustrates a cross sectional view of example stator and rotor cores and windings in a generator 100. In the example of FIG. 1, the generator 100 is a dual-speed wind generator 100 having dual windings 102. The wind generator 100 includes a 1300 kW, 4-pole high-speed winding and a 250 kW, 6-pole low-speed winding. The windings 102 may be positioned within the same stator slots but are connected to separate terminals within a stator terminal box.

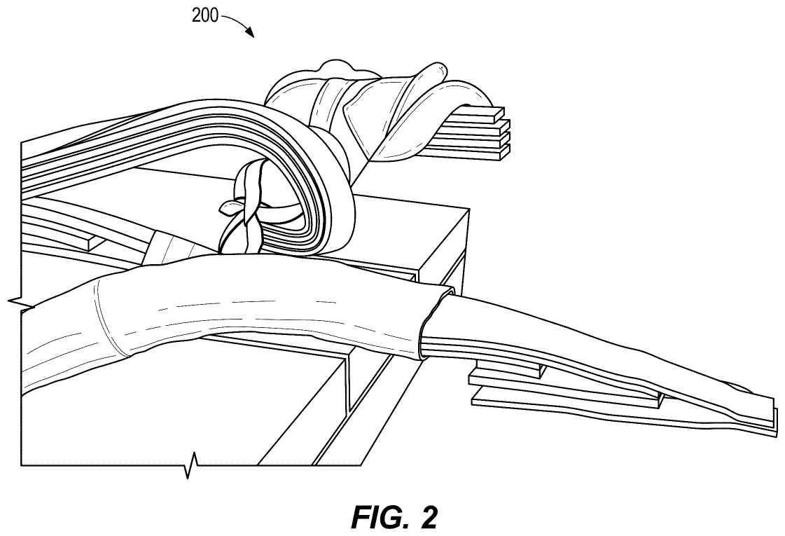

Windings with five or fewer turns per coil experience increased circulating and eddy current losses due to unequal lengths of each turn, particularly when each turn contains multiple parallel paths. These losses may result in reduced output, increased temperature, and reduced life expectancy. In the example of the ABB 1300 kW wind generator, transpositions of the parallel conductors per turn in the high-speed winding in both the series connections and the cross connections are implemented. FIG. 2 illustrates an example of a series cross connection transposition 200.

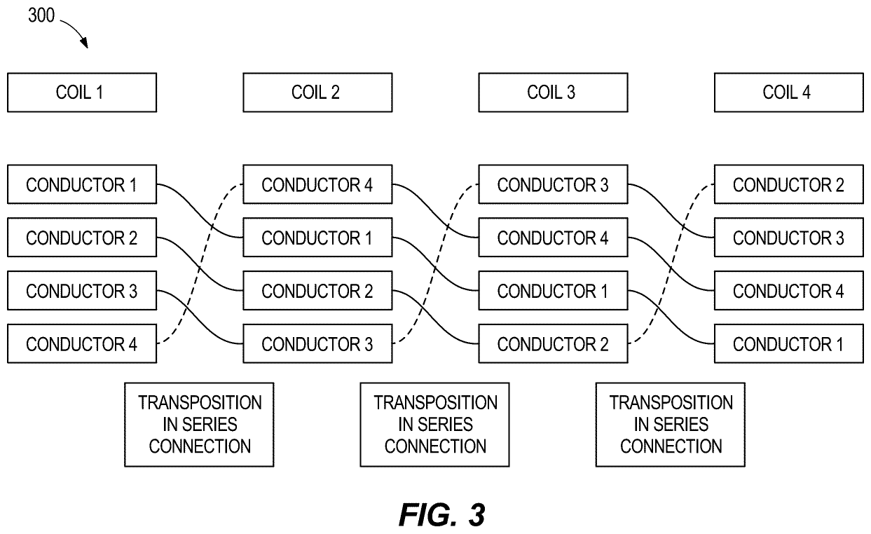

The transposition 200 progressively swaps the position of each parallel conductor to achieve approximately equal lengths for each conductor in the entire winding. FIG. 3 illustrates an example of the transposition of parallel conductors 300 in series connection.

For a full transposition cycle with four conductor in parallel, 3 series connections are utilized between 4 coils. To achieve a full transposition cycle (thus minimizing circulating and eddy current losses), 4 to 1 coil transpositions may be used. The effectiveness of the transposition may be calculated using Equation (1). The effectiveness of the transposition may only be calculated for one leg of a parallel circuit, as the winding is by definition symmetrical.

$$Transposition Effectiveness = \{ \begin{matrix}1 , if R = 0 \\ \frac{C - R}{C} , if 0 < R \leq \frac{C}{2} \\ \frac{R}{C} , if R > \frac{C}{2}\end{matrix} \qquad Equation ( 1 )$$

Where:
C is the number of conductors in parallel per turn ≥2; and
R is the remainder, calculated according to Equation (2):

$$R = ( T + 1 ) - C \cdot ⌊ \frac{T + 1}{C} ⌋ \qquad Equation ( 2 )$$

Where:
T is the number of transpositions in a parallel leg.

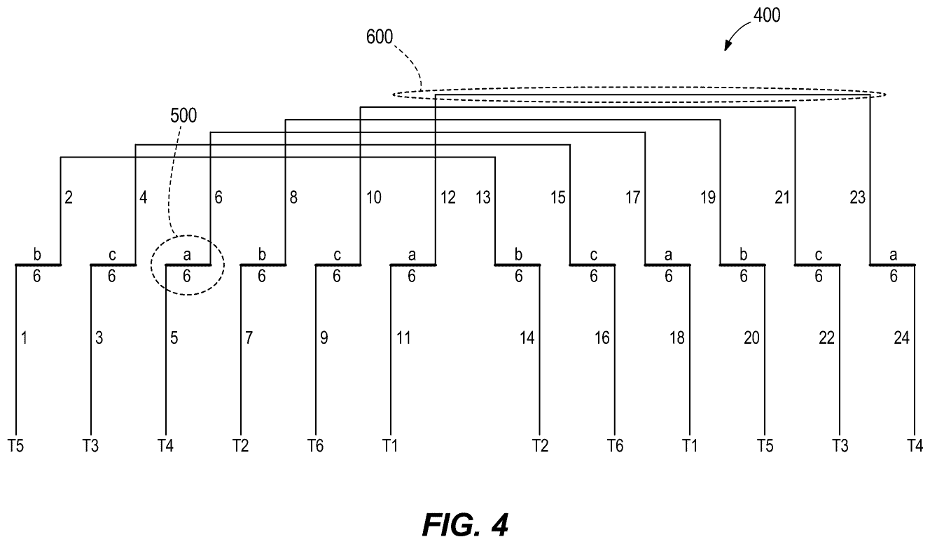

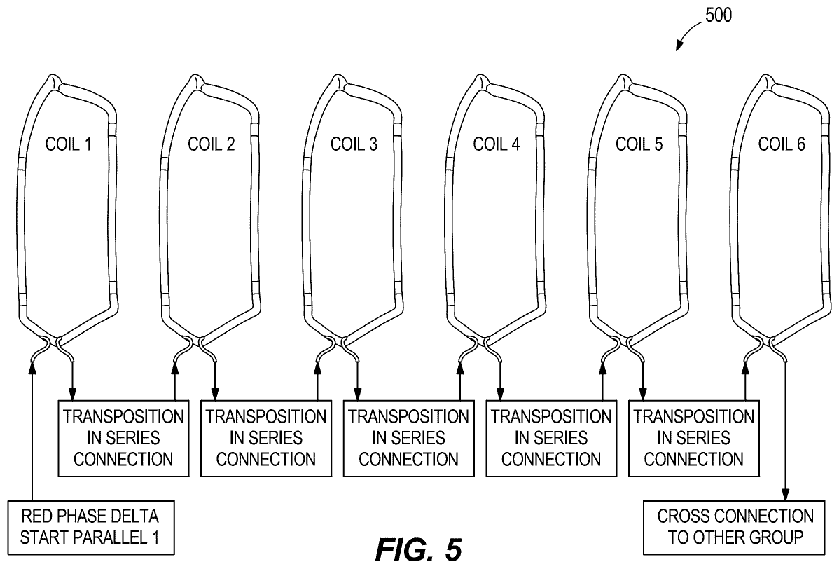

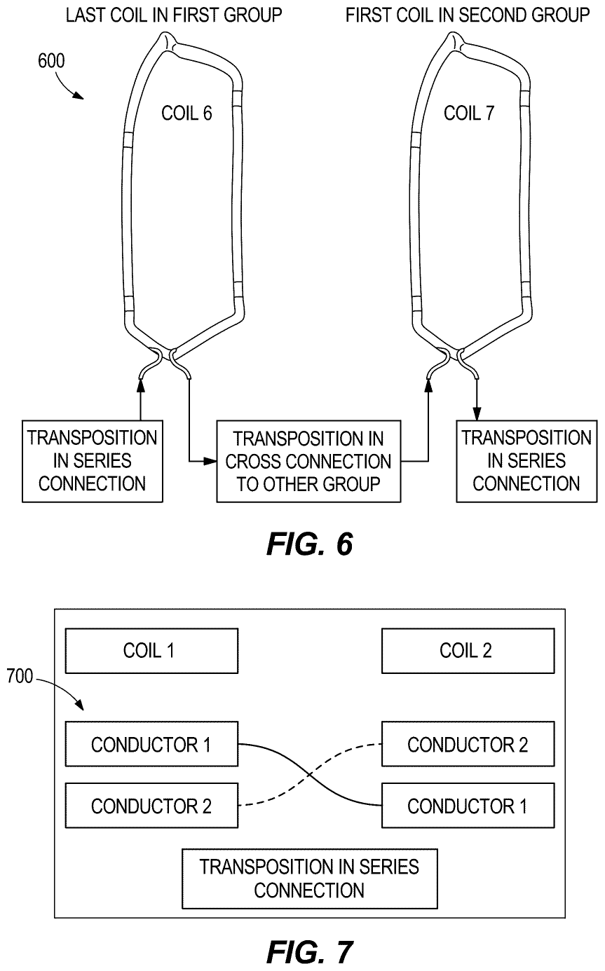

FIG. 4 illustrates a connection diagram for an example high speed winding 400. Detailed Items 500 and 600 highlighted in FIG. 4 are illustrated in FIG. 5 and FIG. 6, respectively. The high speed winding 400 illustrated in FIG. 4 is a two-circuit delta connection with 1 to 7 long cross connections and with 6 leads out.

Detail 500 of FIG. 5 illustrates that between the 6 coils of group 1 are 5 transpositions, which (with reference to FIG. 3) is repeated in the second group of that parallel leg of the phase, resulting in 10 transpositions in total for 12 coils. The transposition effectiveness can be calculated using Equations (1) and (2), as shown in Equations (3) and (4):

$$R = ( T + 1 ) - C \cdot ⌊ \frac{T + 1}{C} ⌋ = ( 10 + 1 ) - 4 \cdot ⌊ \frac{10 + 1}{4} ⌋ = 3 \qquad Equation ( 3 )$$

A transposition effectiveness of 75% provides for 25% of additional circulating and eddy current losses, reducing the machine efficiency increasing temperature rise, and reducing life and reliability.

Detail 600 of FIG. 6 illustrates a connection diagram for the high speed winding cross connections. Particularly, FIG. 6 illustrates a 1 to 7 long cross connection which may have sufficient space to include a cross connection in the cross connection. The additional cross connection may be used to calculate the transposition effectiveness, thus 11 transpositions in total for 12 coils. The transposition effectiveness can be calculated using Equations (1) and (2), as shown in Equations (5) and (6):

$$Transposition Effectiveness = \{ \begin{matrix}1 , if R = 0 \\ \frac{C - R}{C} , if 0 < R \leq \frac{C}{2} = \frac{R}{C} = \frac{3}{4} = 75 \% \\ \frac{R}{C} , if R > \frac{C}{2}\end{matrix} \qquad Equation ( 4 )$$

Accordingly, an additional transposition in the 1 to 7 long cross connections reduces additional circulating and eddy current losses. However, if the winding is connected using 1 to 4 cross connections, there is insufficient space to implement the transpositions.

However, these transpositions are time-consuming to make and the additional connections (which are four times that of standard series connection, since it is 4 parallel wires per turn in this configuration) and insulation introduce additional risks of weak or hot connections and insulation failure. Accordingly, the transpositions described thus far may reduce overall machine reliability. Reducing the number of cross connections may thus increase the reliability and dependability of the wind generator while also reducing repair time and cost.

Examples described herein may provide for improved high speed winding by reducing the number of series connections, thus also reducing the number of transpositions and removing the cross connections.

In some aspects, the turns per coil are increased from 2 to 4. The additional circulating and eddy current losses are inversely proportional to the square of the number of turns, and thus increasing the turns from 2 to 4 may reduce the additional circulating and eddy current losses by 75%.

FIG. 7 illustrates the transposition of parallel conductors 700 in series connection. The transposition of FIG. 7 includes 4 turns per coil, 2 wires in parallel per turn. The transposition progressively swaps the position of each parallel conductor to achieve approximately equal length of each conductor in the entire winding. For a full transposition cycle, for 2 conductors in parallel, only 1 series connection may be utilized between 2 coils. To achieve a full transposition cycle, thus minimizing circulating and eddy current losses, a 2-1 coil transposition may be utilized.

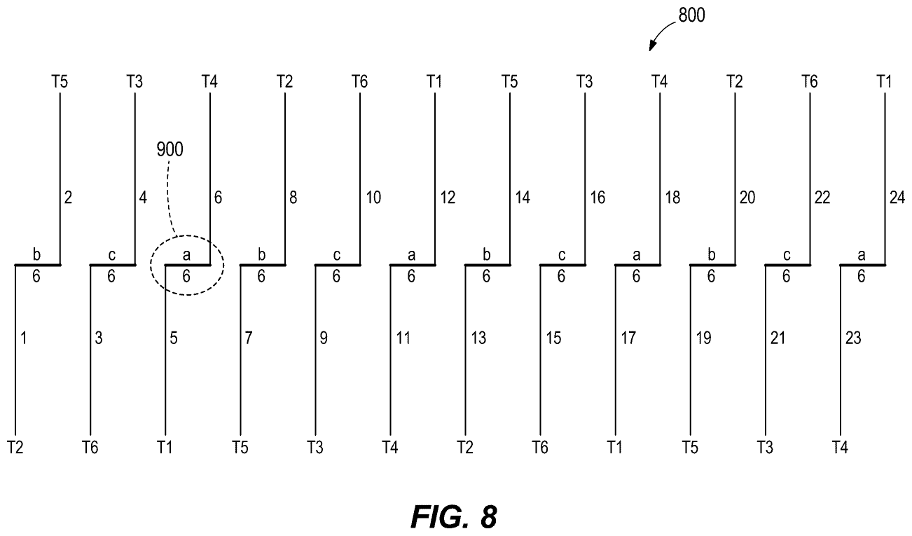

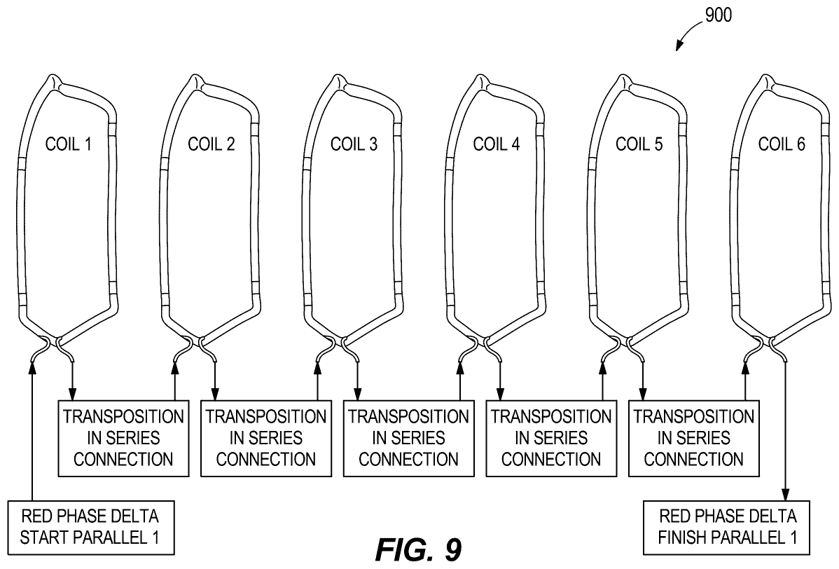

FIG. 8 illustrates a connection diagram 800 of improved high speed windings described herein. The high speed winding of FIG. 8 does not include cross connections. FIG. 9 illustrates Detail 900 highlighted within FIG. 8. Detail 900 provides a cross connection diagram for the improved high speed windings of FIG. 8 having series connections. In Detail 900, between the 6 coils of group 1, there are 5 transpositions, the total for that leg of the parallel circuit. The transposition effectiveness can be calculated using Equations (1) and (2), as shown in Equations (7) and (8):

$$R = ( T + 1 ) - C \cdot ⌊ \frac{T + 1}{C} ⌋ = ( 11 + 1 ) - 4 \cdot ⌊ \frac{11 + 1}{4} ⌋ = 0 \qquad Equation ( 5 )$$

$$Transposition Effectiveness = \{ \begin{matrix}1 , if R = 0 \\ \frac{C - R}{C} , if 0 < R \leq \frac{C}{2} = 1 = 100 \% \\ \frac{R}{C} , if R > \frac{C}{2}\end{matrix} \qquad Equation ( 6 )$$

Thus, aspects described herein reduce additional circulating and eddy current losses without utilizing an additional transposition in the 1 to 7 long cross connections. Table 1 compares the number of transpositions (and thus, additional brazing connections and individual conductor insulation operations) of the improved design of FIGS. 7-9 compared to the design of FIGS. 2-6.

TABLE 1
Comparison of Number of Transpositions

| | Original | Design |
|---|---|---|
| Description | Design | Improvement |
| Number of turns / coil | 2 | 4 |
| Number of series connections per group | 5 | 5 |
| Number of groups | 12 | 12 |
| Number of transposition connections per series | 4 | 2 |
| connection | | |
| Number of transposition connections for all | 5 × 12 × | 5 × 12 × |
| series connections | 4 = 240 | 2 = 120 |
| Number of cross connections | 6 | 0 |
| Number of transposition connections per cross | 4 | 0 |
| connection | | |
| Number of transposition connections for all | 6 × | =0 |
| series connections | 4 = 24 | |
| Total Number of transposition connections | =264 | =120 (−55%) |

Thus, the number of transpositions, brazing joints, and individual insulation operations is reduced by approximately 55%, while the additional circulating and eddy current losses are reduced by approximately 75%.

Accordingly, examples described herein transition (e.g., reconfigure) the high speed winding from a two-circuit delta connection to a four-circuit delta connection. This transition removes the need for cross connections, reduces the number of transpositions, and reduces circulating and eddy currents. The transition also simplifies repair of generators and motors.

The original machine insulation comprises porous electrical insulation tape, typically a composite of mica and polyester, glass, aromatic polyamide, aramid paper, or paper wrapped around the electrical copper conductors. The electrical copper conductors are typically themselves also insulated with insulation, for instance enamel film, polyester film, polyamide-imide (PAI) film, glass yarn, mica composite tapes, aromatic polyamide, aramid, paper, etc. After manufacturing the coils into the required shape, they are wound/inserted into the stator/rotor cores and connected into the required winding configuration. This porous electrical insulation then needs to be saturated by an impregnating resin, typically polyester, epoxy or silicon based. This is typically achieved by means of a vacuum pressure impregnation (VPI) process, in which the part is placed in a chamber and a vacuum is drawn for a period of time. The part is flooded with the impregnating resin, for a period of time, and then a set pressure, typically around 6 bar, is applied for a set period of time. Thereafter, the pressure is released and the part is put in a temperature controlled environment for a period of time, with the purpose of curing the resin.

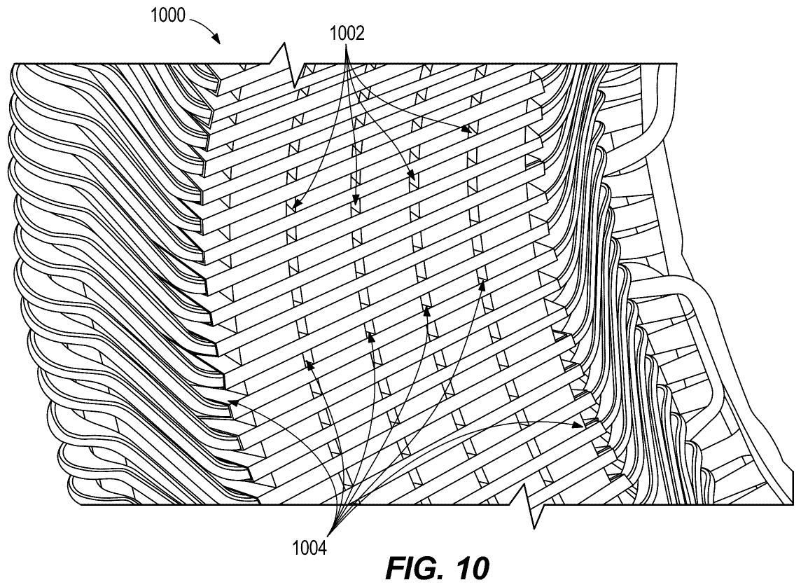

In prior generators, low viscosity epoxy resin was utilized for insulation, as the stator laminations are compressed together in a single core pack with no radial vents. FIG. 10 illustrates an example core 1000 with radial vents 1002. For comparison, as shown in FIG. 10, a core 1000 with radial vents 1002 has significantly more areas of entry 1004 for the VPI resin.

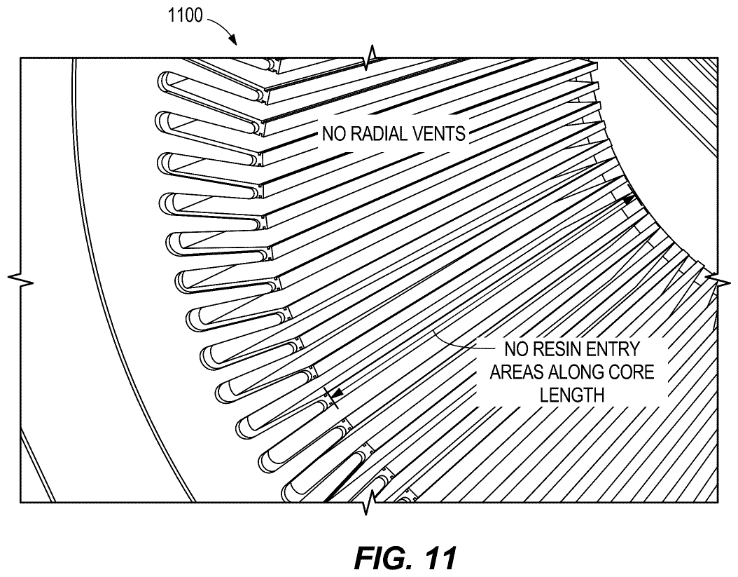

FIG. 11 illustrates an example core 1100 without radial vents. With the core 1100 not having radial vents, the available entry areas for the resin are limited to the ends of the core. The core thus does not have radial vents that would have created additional points of entry for the epoxy resin.

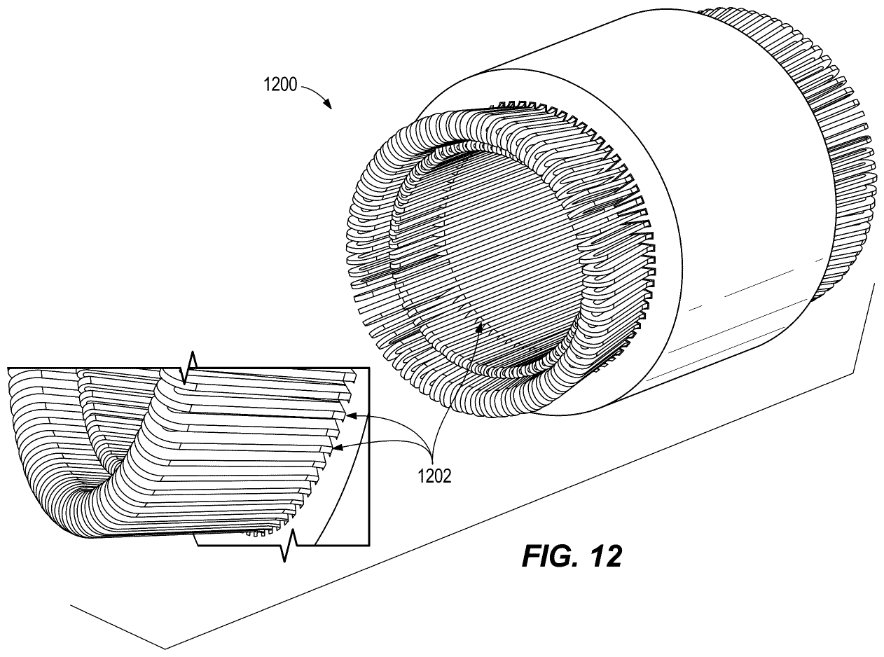

FIG. 12 illustrates an example core 1200 having entry areas 1202 for the resin. The entry areas 1202 for the resin are thus on the ends of the core 1200, and the resin penetrates all the way along the length of the coil to the center of the core 1200. If the resin does not fully penetrate to the center of the core 1200, penetration will be incomplete, and there will be a void in the insulation, which will be mechanically weak and the electrical insulation will be insufficient, resulting in premature failure.

Examples described herein utilize a high viscosity, thixotropic resin which increases environmental protection and physical protection, as well as provides physical strength to the windings. The thixotropic resin is suited for high power, temperature, and environmental cycles found in generator sites, such as wind generator sites.

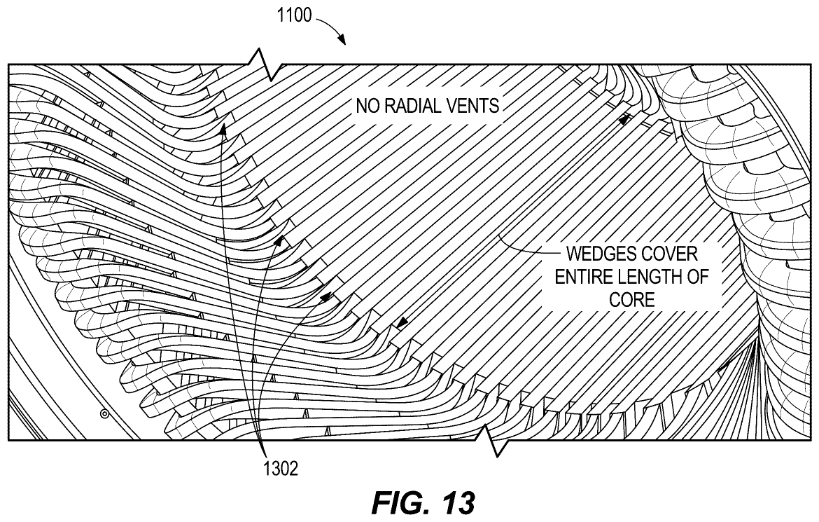

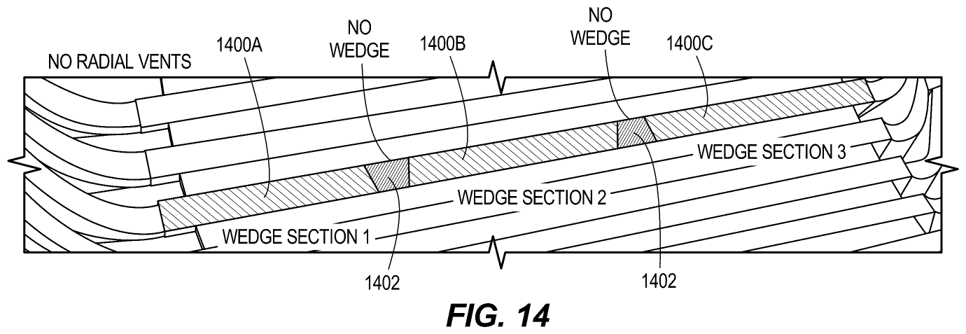

In some implementations, the wedges of the core may be split and/or shortened to assist with penetration of the resin. For example, FIG. 13 illustrates an example core 1300 having entry areas 1302 for the resin. FIG. 14 illustrates a perspective view of an example wedge 1400. The wedges 1400 may be split into three sections 1400A, 1400B, 1400C, making the wedges easier to insert. Additionally, the wedges 1400 may be shortened such that a gap 1402 of approximately 3.175 mm to 19.05 mm (⅛ inch to ¾ inch) is present between each wedge end and an adjacent wedge section, allowing for resin penetration areas.

The designs and methods for constructing, installing, and/or refurbishing stators according to the present disclosure are particularly suitable for use in wind turbine generator applications.

Various features and advantages of the aspects described herein are set forth in the following claims.

What is claimed is:

1. A method for refurbishing a stator for use in an electric machine, the method comprising:
increasing a number of turns per coil forming stator windings of the stator; and
reducing a number of transpositions and cross connections of the stator windings.

2. The method of claim 1, wherein increasing the number of turns per coil includes reconfiguring the stator windings to a four-circuit delta configuration.

3. The method of claim 1, wherein the turns per coil are increased from two turns per coil to four turns per coil.

4. The method of claim 1, wherein a number of parallel circuits forming the stator windings is a whole factor of a number of poles of the stator.

5. The method of claim 4, wherein increasing the number of turns per coil includes increasing the number of turns per coil by a same factor by which a number of parallel circuits is multiplied.

6. The method of claim 1, wherein reducing the number of transpositions and cross connections of the stator windings includes replacing the cross connections of the stator windings.

7. The method of claim 1, further comprising:
providing a thixotropic resin to a core of the stator.

8. An electric machine comprising:
a stator including stator windings configured in a four-circuit delta configuration, wherein a number of turns per coil forming the stator windings include four turns per coil, and wherein a number of parallel circuits forming the stator windings is a whole factor of a number of poles of the stator.

9. The electric machine of claim 8, wherein the stator includes a core comprised of a plurality of wedges, wherein each wedge is split into a plurality of sections, each section separated from an adjacent section by a gap.

10. The electric machine of claim 9, wherein the plurality of sections includes three sections.
